(19) United States
(12) Patent Application Publication
(10) Pub. No.: US 2005/0261975 A1
(43) Pub. Date: Nov. 24, 2005

(54) Graphics-based inventory control system

(76) Inventor: Ross Carver, Somerville, MA (US)

Correspondence Address: DINSMORE & SHOHL LLP, One Dayton Centre, One South Main Street, Suite 1300, Dayton, OH, 45402-2023, US

(21) Appl. No.: 11/180,854

(22) Filed: Jul. 13, 2005

Related U.S. Application Data
(63) Continuation-in-part of application No. 11/110,464, filed on Apr. 20, 2005.
(60) Provisional application No. 60/563,972, filed on Apr. 21, 2004.

(51) Int. Cl. G06F 17/60

(52) U.S. Cl. 705/22

(57) ABSTRACT

A graphics-based inventory control system for creating a visional graphics-based blueprint representation indicating the current placement of product in the sales bays and aisles in a particular location for the tracking of inventory and sales as well as to ensure the accurate placement of the product in accordance to the best practice agreement is disclosed. The graphics-based inventory control system is used to quickly alter off-site the configuration of the visional graphics-based blueprint representation to assist in the planning of future product placement in the remote location is also disclosed. The graphics-based inventory control system can further assist in determining the optimal product placement in the warehouse to streamline the shipping of the products to the individual remote locations by placing the products in the most efficient location in the warehouse for shipping the product out.

### CROSS-REFERENCE TO RELATED APPLICATIONS

This application is a continuation-in-part of U.S. application Ser. No. 11/110,464, filed Apr. 20, 2005, which claims the benefit of U.S. Provisional Application Ser. No. 60/563,972, filed Apr. 21, 2004.

### BRIEF SUMMARY OF THE INVENTION

The present invention relates to an inventory control system and, more particularly to a graphics-based inventory control system for determining the amount, layout, and accuracy of the placement of products in a remote location.

Typically, after a large distributed chain of stores agrees to carry a certain product line and before the product line is sold in the chain of stores, a representative for the product line and a buyer for the chain of stores meet at a central location, most commonly at the buyer's home office. They meet to determine the best practice for selling the product representative's product line in the buyer's chain of stores. In the best practice agreement, the product representative and the buyer decide how much of that product will be sold and inventoried in the individual remote locations of the chain as well as where in the individual remote locations the products will be displayed and positioned.

However, it is often difficult to conceptualize without actually traveling to each of the remote locations as to where the products should best be placed at a particular remote location as well as to how much of each product should be displayed in order to maximize the sales of the product at that particular location. Along the same vein, if the individual remote locations fail to comply with the best practice agreement and fail to display and position the products in the agreed upon site at the remote location, it is frequently difficult for the product representative to relay to the store buyer the associated problems with the current product misplacement without the buyer traveling to the remote location himself to see why the current product misplacement is causing trouble. Additionally, it is also difficult to readily determine why two different remote locations operating under the same best practice agreement within the same region have very different sale figures for the same product without having to physically inspect the display and placement at all the remote locations.

Further still, these problems exist in many other situations, retail as well as non-retail, where the physical management of large quantities of inventory is necessary such as with the warehousing and storage of goods.

Accordingly, there is a need for a graphics-based inventory control system that visually and graphically indicates with representative product graphics the current placement of product. Such a graphics-based inventory control system could use an overhead birds eye graphical view layout indicating the sales bays and aisles of a particular location. Additionally, the graphics-based inventory control system could be used for tracking inventory and sales of the products at a particular remote location. Further still, the graphics-based inventory control system could also be used to ensure the accurate placement and positioning of the product in each of the remote location in accordance with the best practice agreement.

There is also the need for a graphics-based inventory control system for quickly visualizing possible alterations to the current configuration of the sales bays and aisles without physically traveling to each of the remote locations. Using the graphics-based inventory control system off-site will also assist in the planning of future product placement as well as in the forecasting future product orders for the remote locations.

This need is met by the present invention wherein the product representative and the buyer use a graphics-based inventory control system which shows the current product layout and placement of the product in the location for planning inventory placement. Both the product representative and the buyer will have access to the graphics-based inventory control system to manipulate the product layout and placement in order to determine the optimal product placement without physically being present and actually moving the product inventory at the remote location until the optimal placement is determined. The graphics-based inventory control system also provides for visual graphics-based output of the current product layout at the remote location so that the product representative can make available to the buyer a visual depiction of the product placement layout for accurate tracking of compliance of each individual location to agreed upon product placement by the best practice agreement.

In accordance with one embodiment of the present invention, the graphics-based inventory control system will assist in determining the optimal placement with respect to other like products from other vendors at the remote location to optimize sales.

In accordance with another embodiment of the present invention, the graphics-based inventory control system will assist in determining the sales performance of the product representative by tying performance to product sales versus size of the inventory at the remote location.

In accordance with yet another embodiment of the present invention, the graphics-based inventory control system will assist in determining the optimal product placement in the warehouse storing the product in order to streamline the shipping of the products to the individual remote locations by placing the products in the most efficient location in the warehouse for shipping the product out.

Accordingly, it is a feature of the embodiments of the present invention to provide a graphics-based inventory control system that creates an accurate visual graphics-based blueprint representation of the aisles and sales bays and the placement of the product in those aisles and sales bays at a remote location for the tracking of product inventory in the remote location and for insurance of compliance with the best practice agreement by the remote location.

It is another feature of the embodiments of the present invention to provide a graphics-based inventory control system that creates an accurate visual graphics-based blueprint representation of a warehouse or storage yard and the placement of products in that warehouse or storage yard for the tracking of the optimal placement of products to streamline the delivery of those products.

Other features of the embodiments of the present invention will be apparent in light of the description of the invention embodied herein.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals and in which:

FIG. 1 is a schematic representation of various remote locations that are in communication with a home office according to an embodiment of the present invention;

FIG. 2 is an illustration of a computer screen shot illustrating the birds eye view blueprint of the layout of the aisles and bays at a remote location according to an embodiment of the present invention;

FIG. 3 is an illustration of a computer screen shot illustrating a sales bay planning layout for the placement of the product in the remote location according to an embodiment of the present invention;

FIG. 4 is another illustration of a computer screen shot illustrating an end cap sales bay planning layout for the placement of the product in the remote location according to an embodiment of the present invention;

FIG. 5 is an illustration of a computer screen shot illustrating the quick keys command list according to an embodiment of the present invention;

FIG. 6 is an illustration of a computer screen shot illustrating the sales report for the remote location according to an embodiment of the present invention.

### DETAILED DESCRIPTION

In the following detailed description of the embodiments of the present invention, reference is made to the accompanying drawings that form a part hereof, and in which is shown by way of illustration, and not by way of limitation, specific embodiments of the present invention in which the invention may be practiced. It is to be understood that other embodiments may be utilized and that changes may be made without departing from the spirit and scope of the present invention.

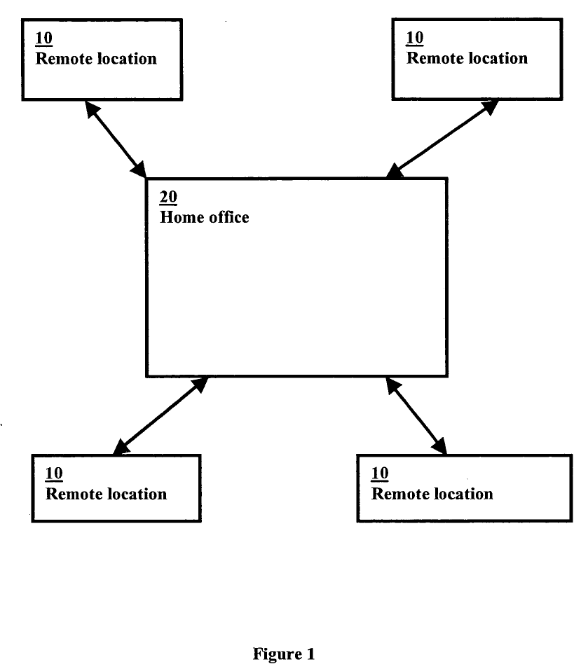

FIG. 1 is a schematic representation of various remote locations 10 that are under authorization and control of a home office 20. In one embodiment, the remote locations 10 can be any location which displays and sells products, such as, for example, a home improvement store, toy store, clothing store, gas station, a grocery store or any other similar type retail location. The home office 20 can be any central located office that oversees the product lines being sold in the remote locations 10. A representative of a particular product line will meet with a buyer for several remote locations 10 at the home office 20. After agreeing to carry the product line of the product representative, the product representative and the buyer will formulate a best practice agreement for how to best display and position the products offered by the product representative at each of the different remote locations 10.

The product representative will then visit each of the remote locations 10 within the territory of the home office 20. The product representative creates in the graphics-based inventory control system an overhead birds eye view blueprint of the overall remote location 10 where the product line will be sold as well as a layout of the particular sales aisles, bulk stacks and bay areas where the product line will be displayed in the remote location 10 according to the best practice agreement. The graphics-based inventory control system can be resident on any computing device such as, for example, a personal computer, a laptop computer, a personal digital assistant (PDA) or any other similar type device. The product representative then enters the location blueprint, product display areas, and the products that will be sold in that particular remote location 10 into the graphics-based inventory control system. The product representative and the buyer will then use these created layouts throughout the year to plan for sales aisle, bulk stacks and bay area configuration and product placement in those aisles and bays in the remote location 10. The product representative can take the layouts to the remote locations 10. In the alternative, the product representative can mail the layouts to the remote locations 10, send them electronically to the remote locations 10 via facsimile, email or use any other suitable of method of getting the layouts to the remote locations 10 without having to physically travel to that remote location 10.

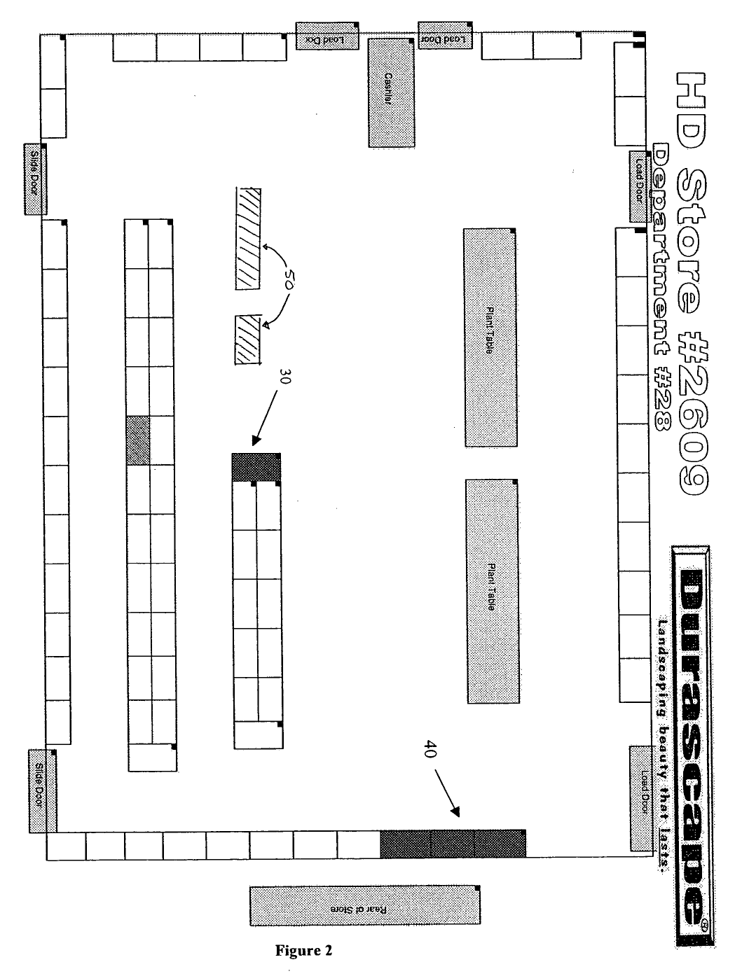

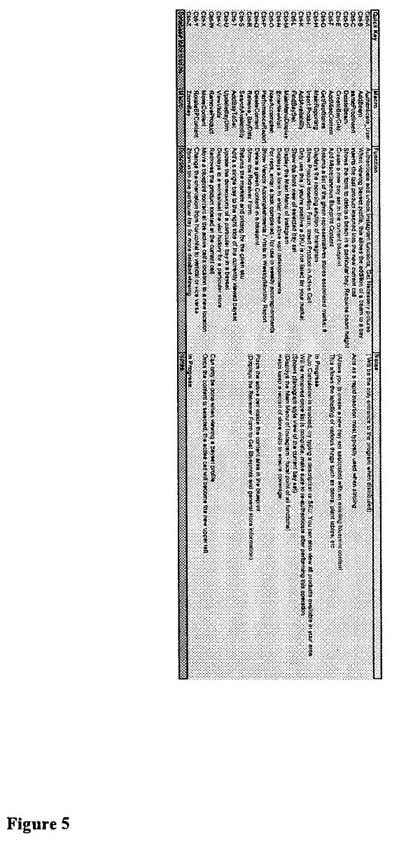

FIG. 2 illustrates an example of what the overhead birds eye view blueprint of the layout of a remote location 10 may look like. The blueprint will indicate the remote location 10 by an unique store number. The blueprint will also indicate the department that the blueprint is illustrating at the remote location 10. The sales aisles, bay areas, and bulk stacks 30, 40, 50 where the product line for the particular product representative should be displayed and position will be shaded on the overhead birds eye view blueprint. The shaded areas 30, 40 represent links to the product sales bay layout for the placement of products at that remote location 10. The product representative can edit the overhead birds eye view blueprint to reflect any changes in the configuration of the layout of the remote location 10 through the use of the menu of quick keys command list as illustrated in FIG. 5. The blueprint will indicate the last time the blueprint was modified and by whom.

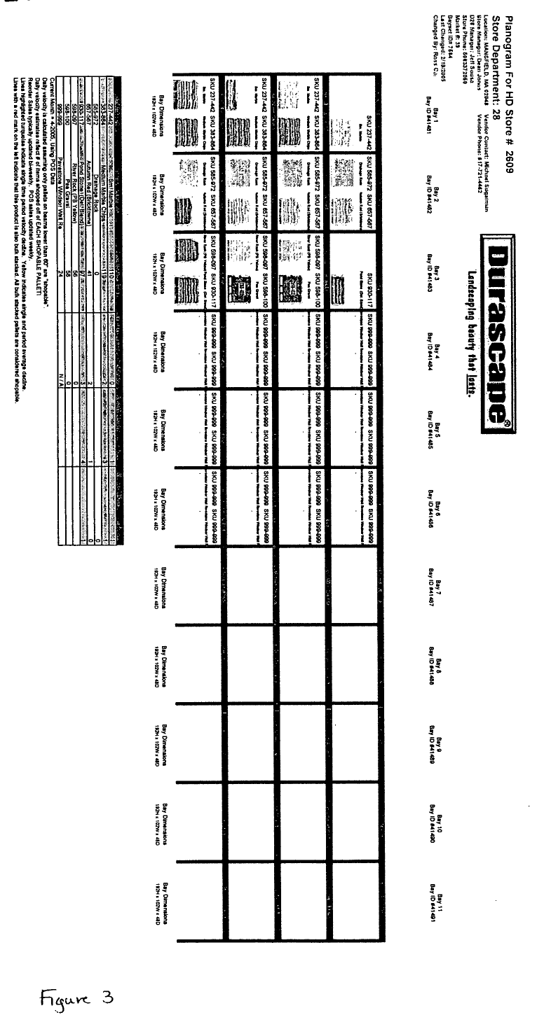

FIG. 3 illustrates an example of the graphical sales bay area layout for the placement of the product in the remote location 10 for area similar to the shaded area 40 in the visual overhead birds eye view blueprint in FIG. 2. Through the use of the graphics-based inventory control system, the product representative can insert the aisles and product sale bays as they are currently configured at the remote location 10. Again, through the use of the menu of quick keys command list, illustrated in FIG. 5, the product representative can alter the aisle and the product sales bay configurations. The product representative manipulates the configuration of each sales bay by, for example, changing the height and width of the product sales bay. After the product representative is satisfied with the configuration of the product sales bay opening, he can place graphical depictions of each of the products in the product line to be sold in the remote location 10 in the various configuration of the various bays to determine the best layout for a particular product without having to be physically present at the remote location 10. The product representative can also adjust the bay openings after inserting the graphical depictions of the product to arrive at the best configuration. Thereby, the system allows the product representative and buyer to know how much product is being displayed at a particular remote location, where the product is displayed and how the product is displayed without physically having to travel to the remote location 10. For example, if the product representative's product line is a variety of different types of paving stones, the graphics-based inventory control system allows the product representative and the buyer to plan and ensure that the patio paving stones of the product representative's product line are displayed near or with the other patio products offered for sale at the remote location 10.

The graphics-based inventory control system can be uses to calculate the average daily unit sales per product area. This value can be calculated either by re-order sales or by point-of-sale data supplied by the remote location 10. The re-order sales numbers are typically updated bi-weekly. The point-of-sale numbers are updated weekly. An estimated inventory count can be graphically depicted in the graphical sales bay area layout. The estimated current inventory can be based on shipments into the remote location 10 and the average rate out. The estimated current inventory value can then be used to calculate turn rates of the product. The daily turn rate is calculated by using only product areas that are “shopable,” or available for purchase by the customer. For example, shopable can mean only those product areas placed in sales bay area that have beams lower than 60.″ The daily turn rate will be calculated only for those shopable product areas. The daily turn rate estimates reflect the number of items sold from each shopable product area. All bulk stacked product areas are considered shopable.

The daily turn rate can also be used to notify the product representative of possible advanced product outages. For example, sales bay areas that could contain product but currently are not based on inventory counts are illustrated as having just the outlines of graphical depictions of products (i.e., the graphical depictions appear to be transparent). The product representative can then view the estimated remaining inventory at a remote location 10 at a given time without having to travel to the remote location 10.

The graphics-based inventory control system also offers a method for the product representative to produce a list that graphically demonstrates to the buyer the misplacement of product lines at individual remote locations 10 that are not in compliance with the best practice agreement. The graphics-based inventory control system would provide the product representative with a realistic overhead birds eye view blueprint and sales aisle and bays configuration graphically showing the non-compliance of product misplacement at those remote locations 10. The buyer can then address the non-compliance with those individual remote locations 10 with the added ammunition of the graphical layouts from the graphics-based inventory control system depicting the non-compliance.

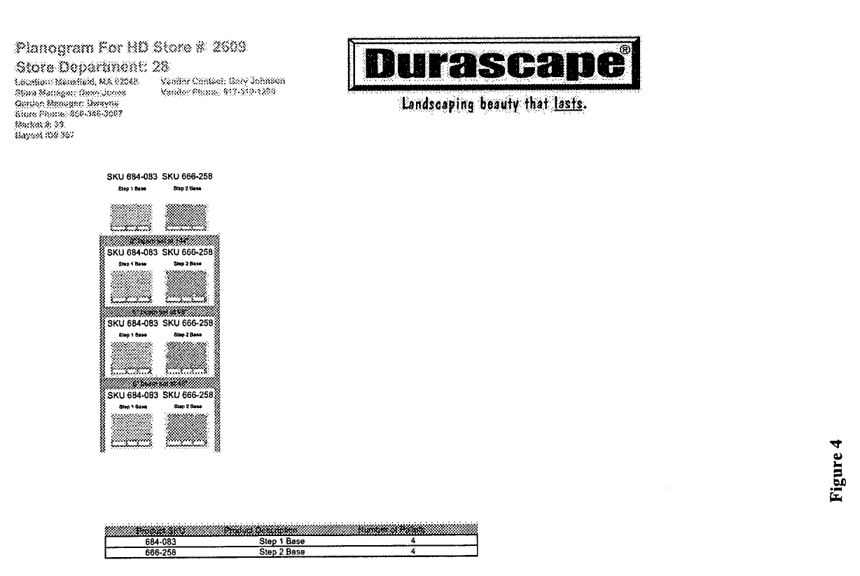

FIG. 4 exemplifies another example of an illustration of the graphical planning layout for the placement of the product in the remote location for an area similar to the shaded area 30 in the visual overhead birds eye view blueprint of FIG. 2. This shaded area 30 is representative of an end cap display that is used to place products at the end of a sale aisle that contains similar product from other vendors. For example, continuing with the paving stone product line example from above, patio paving stones would be placed in an end cap display at the end of an aisle which is displaying other patio products, such as, for example, patio furniture, outdoor lighting, and gas grills.

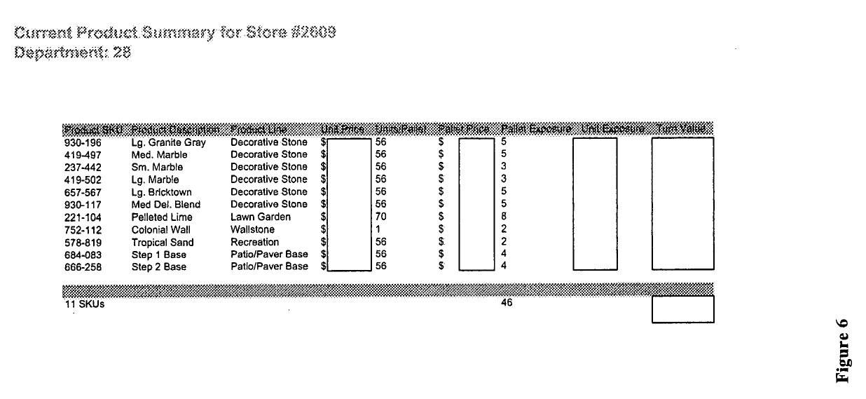

FIG. 6 is an illustration of a sales report for the remote location 10 that can be calculated to determine the amount sales generate with the particular placement of a product line at a particular remote location 10. The graphics-based inventory control system keeps track of evaluation metrics, such as, for example, the amount of sales generated and the inventory moved, by a particular configuration and layout from an individual remote location 10. The product representative and buyer can review the sales reports to determine the advantages of a particular configuration and layout and to conclude which configuration and layout produces the best sales and inventory movement within a particular sales region. Using the information from the sales report, the layout and configurations used in one remote location 10 can be adjusted to reflect the configuration of other remote locations 10 that have higher sales and inventory movement for that product line. Lines of the sales report can be highlighted in different colors to indicate declines in turn rates. For example, a line in the sales report can be highlighted in turquoise to indicate a single time period velocity decline and another line in the report can be highlighted in yellow to indicate a single and period average decline. Additionally, the lines of the sales report can be marked in red to indicate that this product is also bulk stacked.

Additionally, the performance of the product representative is typically tied to the movement of inventory in terms of sales. Because the amount of inventory varies between regions and between individual remote locations 10, these sales report are beneficial to the product representative for determining more accurately the performance of the product representative since sales numbers can be compared against actual movement of the amount of inventory in a particular sales region. These sales report figures better represent the actual performance of the product representative in contrast to simply requiring a flat sales number across all sales regions.

In another embodiment, the remote locations 10 in FIG. 1 would represent warehouse, or plant yard, locations where the product lines are stored until delivery to retail locations. The home office 20 would represent the home corporate office for the product line. In this embodiment, the graphics-based inventory control system can be used to position the product within the warehouse so that the delivery process would be expedited. The graphics-based inventory control system would assist in positioning the more popular product in the most accessible location to make the delivery process more efficient. Then the different warehouse locations could be compared to determine which configuration is most efficient and produces the fastest load time of the products onto the trucks for delivery.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

1. A method for tracking and placing product inventory at a location using a graphics-based inventory control system, the method comprising:
creating an electronic graphics-based layout of product display areas at said location in said graphics-based inventory control system according to a best practice agreement, wherein said electronic graphics-based layout is manipulated by said graphics-based inventory control system;
displaying said graphics-based layout on a output device; and
placing said product inventory at said location according to said graphics-based layout.

2. The method of claim 1, further comprising:
shading graphical areas on said display of said graphics-based layout where said product inventory will be placed within said graphics-based layout according to said best practice agreement.

3. The method of claim 2, further comprising:
linking said shaded graphical areas to a graphics-based representation of said product display areas of said location.

4. The method of claim 1, further comprising:
tracking product movement into and out of said product display areas.

5. The method of claim 1, further comprising:
tracking adherence of product placement in said location with said best practice agreement.

6. The method of claim 1, wherein placing said product inventory is placed near like products in said location.

7. The method of claim 1 further comprising:
planning future product placement at said location based on said product movement.

8. The method of claim 1 further comprising:
displaying estimated inventory at said location based on shipments of said products into said location and average rate out of said products.

9. The method of claim 8, further comprising:
calculating daily turn rate based on said estimated inventory.

10. The method of claim 1 further comprising:
calculating average daily unit sales per product space based on said product movement.

11. The method of claim 10, wherein said average daily unit sales are calculated using re-order sales data.

12. The method of claim 11, wherein said re-order sales data are updated bi-weekly.

13. The method of claim 10, wherein said average daily unit sales are calculated using point-of-sale data supplied by said location.

14. The method of claim 13, wherein said point-of-sale data are updated weekly.

15. The method of claim 1, further comprising:
producing a sales report for a sales representative affiliated with said location based on product movement and sales generated with a particular placement of said products at said location.

16. The method of claim 15, further comprising:
tying performance of said sales representative based on said sales report.

17. The method of claim 1, wherein said location displays and sells products.

18. The method of claim 1, wherein said location is identified by a unique store number.

19. The method of claim 1, wherein a department of said location is indicated on said graphics-based layout.

20. The method of claim 1 further comprises:
editing the configuration of said graphics-based layout.

21. The method of claim 1, further comprising:
configuring said graphical product display areas.

22. The method of claim 21, wherein configuring occurs through the use of a quick keys command list menu.

23. The method of claim 21, wherein configuring includes changing the height and width of said graphical product display areas.

24. The method of claim 21, further comprising:
placing graphical depictions of said product in said graphical product display areas.

25. The method of claim 1, further comprising:
placing graphical depictions of said product in said graphical product display areas.

26. The method of claim 25, further comprising:
configuring said graphical product display areas.

27. The method of claim 26, wherein said configuring further comprises changing the height and width of said graphical product display areas.

28. The method of claim 1, wherein said product display areas comprises a sales aisle, a bay area, a bulk stack or combinations thereof.

29. The method of claim 1, wherein said location is remote from a central home office.

30. The method of claim 29, wherein said central home office determines which said products will be displayed at said remote location.

31. The method of claim 29, wherein said creating said graphics-based layout occurs at said central home office for said remote location.

32. The method of claim 31, further comprising:
sending said graphics-based layout created at said central home office to said remote location for implementation.

33. The method of claim 32, wherein said sending comprises postal mailing, faxing, electronic mailing or combinations thereof.

34. The method of claim 1, wherein said location is a site for storing products until delivery to another location.

35. The method of claim 34, further comprising:
positioning said products within said site, wherein said positioning of said products streamlines the procedure for shipping products out of said site.

36. The method of claim 34, wherein positioning said products places the more popular products in the most accessible areas within said site.

37. The method of claim 34, further comprising:
comparing said positioning of said products between different locations to determine said positioning that produces the fastest movement of said products out of said site.

38. The method of claim 34, wherein said site comprises a warehouse, a plant yard, or combinations thereof.

39. A method for tracking and placing product inventory at a location using a graphics-based control system, the method comprising:
establishing a graphics-based layout of product display areas at said location;
placing products at said location based on said graphics-based layout;
tracking product movement into and out of said location; and
positioning said product inventory at said location such that said product inventory having the greatest product movement into and out of said location is placed in an area having the greatest accessibility relative to moving said product inventory out of said location.

40. The method of claim 39, further comprising:
comparing said positioning of said products between different locations to determine said positioning that produces the fastest product movement.

41. The method of claim 39, wherein said location comprises a warehouse, a plant yard, or combinations thereof.

42. A method for tracking and placing product inventory at a location using a graphics-based control system, the method comprising:
establishing a graphics-based layout of product display areas at said location;
placing products at said location into said product display areas in accordance to a best practice agreement;
tracking product movement into and out of said location;
calculating average daily unit sales per product display area based on said product movement.

43. The method of claim 42, further comprising:
displaying estimated inventory at said location based on said average daily unit sales.

44. The method of claim 43, further comprising:
calculating daily turn rate based said estimated inventory.

45. The method of claim 44, wherein said daily turn rate is calculated for products that are readily available to a customer.

46. The method of claim 42, further comprising;
notifying said product representative of potential product outages at said location.

47. The method of claim 42, further comprising;
notifying said product representative of potential product outages at said location by displaying said potential product outages as outlined graphic depictions of said products.

48. A method for tracking and placing product inventory at a location using a graphics-based control system, the method comprising:
establishing a graphics-based layout of product display areas at said location;
placing products at said location into said product display areas in accordance to a best practice agreement;
tracking product movement into and out of said location; and
producing a sales report for a sales representative affiliated with said location based on sales generated with a particular placement of said products at said location.

49. The method of claim 48, wherein declines in sales are highlighted on said sales report.

50. The method of claim 49, wherein declines in sales are highlighted on said sales report as a single period decline.

51. The method of claim 49, wherein declines in sales are highlighted on said sales report as a single period and period average decline.

52. The method of claim 48, wherein said sales report indicates type of product display area used for said products.

53. The method of claim 48, further comprising;
using said sales report for product placement at other locations.

54. The method of claim 48, further comprising;
tying compensation of said product representative on product movement at said location.
